(19) United States
(12) Patent Application Publication
(10) Pub. No.: US 2022/0295307 A1
(43) Pub. Date: Sep. 15, 2022

(54) MDT FOR SECONDARY CELL GROUP AND SECONDARY CELLS

(71) Applicant: Telefonaktiebolaget LM Ericsson (publ), Stockholm (SE)

(72) Inventors: Malik Wahaj ARSHAD, STOCKHOLM (SE); Robert PETERSEN, LINKÖPING (SE); Pradeepa RAMACHANDRA, LINKÖPING (SE); Wei SHEN, LINKÖPING (SE)

(21) Appl. No.: 17/633,554

(22) PCT Filed: Jul. 2, 2020
(86) PCT No.: PCT/IB2020/056272

§ 371 Date: Feb. 7, 2022

Related U.S. Application Data
(60) Provisional application No. 62/884,293, filed on Aug. 8, 2019.

(51) Int. Cl. H04W 24/02; H04W 24/10; H04W 76/15

(52) U.S. Cl. CPC H04W 24/02; H04W 24/10; H04W 76/15

(57) ABSTRACT

Disclosed are methods performed by a management node for implementing minimization of drive testing, MDT, in a wireless communication network that supports dual connectivity. Methods include generating a master cell group, MCG, MDT configuration for a user equipment, UE; generating a secondary cell group, SCG, MDT configuration for the UE; and transmitting the MCG MDT configuration and the SCG MDT configuration to one or more radio access network, RAN, nodes.

### BACKGROUND

Minimization of Drive Testing (MDT) is a feature of the Long Term Evolution (LTE) wireless communication systems that was developed to allow a network operator to obtain localized network quality measurements from user equipments (UEs) in the network. Traditionally, to obtain field data about network quality, operators would conduct a “drive test” in which a technician drives a testing vehicle around within a network coverage area and takes measurements of various network performance metrics (e.g, received power levels, interference levels, etc.) or UE performance (e.g, call drop frequency, throughput, handover performance, cell reselection performance, etc.) at various locations within the network coverage area. Performing such a drive test may be expensive and time consuming. MDT enables network operators to utilize users' equipment to collect radio measurements and associated location information to assess network performance, while reducing the costs associated with traditional drive tests.

MDT was initially studied in LTE Rel-9 (TR 36.805) with the purpose to minimize the actual drive tests. MDT has been introduced since Rel-10 in LTE. MDT has not been specified for NR in the involved standards in RAN2, RAN3 and SA5 groups.

The use cases in TR 36.805 include coverage optimization, mobility optimization, capacity optimization, parameterization for common channels and QoS verification.

Normal radio resource management (RRM) mechanisms only allow for measurements to be reported when the UE has an RRC connection with a particular cell, and there is sufficient UL coverage to transport the MEASUREMENT REPORT. This restricts measurements to be collected from UEs not experiencing radio link failure (RLF) and experiencing sufficient UL coverage. Moreover, there is no accompanying location information in normal RRM measurements.

When MDT was introduced in LTE Rel-10, it was decided to include MDT as a part of the Trace function which is able to provide very detailed logging data at call level. Based on the methods of activating/deactivating trace and trace configuration, the trace function can be classified into the following two aspects.

Management activation/deactivation: Trace Session is activated/deactivated in different Network Elements (NE) directly from the Element Manager (EM) using the management interfaces of those NEs.

Signalling Based Activation/Deactivation: Trace Session is activated/deactivated in different NEs using the signalling interfaces between those elements so that the NEs may forward the activation/deactivation originating from the EM.

On the other hand, MDT can be classified as Area-based MDT or Signalling-based MDT from the use case perspective illustrated below.

Area based MDT: MDT data is collected from UEs in a specified area. The area is defined as a list of cells (UTRAN or E-UTRAN) or as a list of tracking/routing/location areas. Area based MDT is an enhancement of the management-based trace functionality. Area based MDT can be either a logged MDT or Immediate MDT.

Signalling based MDT: MDT data is collected from one specific UE. The UE that is participating in the MDT data collection is specified as IMEI(SV) or as IMSI. Signalling based MDT is an enhancement of the signalling based subscriber and equipment trace. Signalling based MDT can be either a logged MDT or Immediate MDT.

In LTE, for Area based MDT, the MDT control and configuration parameters are sent by the Network Management function directly to the eNB. Then, the eNB selects UEs which fulfill the criteria including area scope and user consent and starts the MDT data collection. For signaling-based MDT, i.e., UE specific MDT, the MDT control and configuration parameters are sent by the Network Management to the mobility management entity (MME), which then forwards the parameters to eNB associated with the specific UE.

FIG. 1 summarizes the classification of the types of MDT.

Logged MDT measurements are tagged by the UE with location data in the following manner. ECGI or Cell-Id of the serving cell when the measurement was taken is always included.

Detailed location information (e.g. GNSS location information) is included if available in the UE when the measurement was taken. If detailed location information is available, the reporting consists of latitude and longitude data associated with the measurements. Depending on availability, altitude, uncertainty and confidence may be also additionally included. The UE tags available detailed location information only once with upcoming measurement sample, and then the detailed location information is discarded. Thus, the validity of detailed location information is implicitly assumed to be one logging interval.

For Immediate MDT, the M1 measurements are tagged by the UE with location data in the following manner.

Detailed location information (e.g. GNSS location information) is included if available in the UE when the measurement was taken. If detailed location information is available, the reporting consists of latitude and longitude. Depending on availability, altitude, uncertainty and confidence may be also additionally included.

The UE should include the available detailed location information only once. If the detailed location information is obtained by GNSS positioning method, GNSS time information is included. For both event-based and periodic reporting, the detailed location information is included if the report is transmitted within the validity time after the detailed location information was obtained. The validity evaluation of detailed location information is left to UE implementation.

For signalling based MDT, the Core Network (CN) does not initiate MDT towards a particular user unless the user consent is available.

For area-based MDT, the CN indicates to the radio access network (RAN) whether MDT is allowed to be configured by the RAN for this user considering, for example, user consent and roaming status, by providing management-based MDT allowed information consisting of the Management Based MDT Allowed indication and optionally the Management Based MDT PLMN List. The management-based MDT allowed information propagates during inter-PLMN handover if the Management Based MDT PLMN List is available and includes the target PLMN.

The same user consent information can be used for area-based MDT and for signaling-based MDT. Thus, there is no need to differentiate the user consent per MDT type. Collecting user consent may be done via a customer care process. The user consent information availability is considered as part of the subscription data and as such this is provisioned to the Home Subscriber Server (HSS) database.

### BRIEF SUMMARY

Some embodiments are directed to methods performed by a management node (500) for implementing minimization of drive testing, MDT, in a wireless communication network that supports dual connectivity. Such methods may include generating a master cell group, MCG, MDT configuration for a user equipment, UE, generating a secondary cell group, SCG, MDT configuration for the UE, and transmitting the MCG MDT configuration and the SCG MDT configuration to one or more radio access network, RAN, nodes.

In some embodiments, transmitting the MCG MDT configuration includes transmitting the MCG MDT configuration to a master node, MN, serving the MCG, and transmitting the SCG MDT configuration includes transmitting the SCG MDT configuration to a secondary node, SN, serving the SCG.

Some embodiments provide that the MCG MDT configuration and the SCG MDT configuration are generated according to different protocol levels based on different levels of protocol supported by the MN and the SN.

In some embodiments, transmitting the MCG MDT configuration and the SCG MDT configuration includes transmitting the MCG MDT configuration and the SCG MDT configuration to a master node, MN, serving the MCG.

Some embodiments provide that transmitting the MCG MDT configuration includes transmitting the MCG MDT configuration to a master node, MN, serving the MCG.

In some embodiments, transmitting the SCG MDT configuration includes transmitting the SCG MDT configuration to a secondary node, SN, serving the SCG.

In some embodiments, the management node includes a first management node and a second management node, the MCG MDT configuration is generated by a first management node and the SCG MDT configuration is generated by a second management node. In some embodiments, the first management node transmits the MCG MDT configuration to a master node, MN, serving the MCG, and the second management node transmits the SCG MDT configuration to a secondary node, SN, serving the SCG.

Some embodiments provide that transmitting the MCG MDT configuration and the SCG MDT configuration to one or more radio access network, RAN, nodes to the UE comprises transmitting a MDT configuration to a first RAN node.

In some embodiments, transmitting the MCG MDT configuration and the SCG MDT configuration to one or more radio access network, RAN, nodes comprises transmitting an MDT configuration that includes both MCG-related configuration information and SCG-related configuration information to a first RAN node.

Some embodiments provide that the MDT configuration that is transmitted to the first RAN node UE is configured to be transmitted to the UE by the first RAN node.

In some embodiments, the MDT configurations include management based MDT configurations, area based MDT configurations, and/or signaling based MDT configurations.

Some embodiments provide that the UE is connected in a dual connectivity arrangement of EN-DC, NE-DC, NG-EN-DC, NR-NR DC, or E-UTRA-E-UTRA DC.

In some embodiments, the UE is connected to a secondary cell via carrier aggregation.

In some embodiments, the MDT configurations are generated by a management node that includes a network manager, a domain manager, an element manager or a combination of any these entities.

Some embodiments provide that the management node includes a first management node that is associated with a master node, MN, and a second management node that is associated with a secondary node, SN, and the first management node coordinates with the second management node to generate the MCG MDT configuration, and the first management node coordinates with a third management node (502) to generate the SCG MDT configuration.

Some embodiments are directed to a management node configured to perform operations disclosed herein.

Some embodiments are directed to a management node including a processing circuitry and a memory coupled to the processing circuitry, wherein the memory comprises computer readable program instructions that, when executed by the processing circuitry, cause the management node to perform any operations disclosed herein.

Some embodiments are directed to methods of operating a radio access network, RAN, node, for implementing minimization of drive testing, MDT, in a wireless communication network that supports dual connectivity. Such methods include receiving a master cell group, MCG, and/or secondary cell group, SCG, MDT configuration for a user equipment, UE, from a management node and causing the MCG MDT configuration and/or the SCG MDT configuration to be provided to the UE.

In some embodiments, the RAN node includes a master node that serves the MCG or a secondary node that serves the SCG.

Some embodiments provide that one of the MCG MDT configuration or the SCG MDT configuration includes a logged MDT configuration.

Some embodiments include providing the UE with an indication of whether to log MDT data for the MCG or the SCG.

Some embodiments include providing the UE with an indication of whether to log MDT data for the MCG and the SCG sequentially.

Some embodiments include providing the UE with an indication of whether to overwrite an existing MDT configuration.

In some embodiments, receiving the MCG MDT configuration or the SCG MDT configuration includes receiving a generic MDT configuration and the method includes modifying the generic configuration with MCG related parameters or SCG related parameters prior to provisioning the MDT configuration to the UE.

In some embodiments, receiving the MCG MDT configuration or the SCG MDT configuration includes receiving an MDT configuration that includes both MCG related parameters and SCG related parameters.

In some embodiments, the UE is connected to a secondary cell via carrier aggregation.

Some embodiments are directed to a radio access network node configured to perform operations according any embodiments disclosed herein.

Some embodiments are directed to a radio access network, RAN, node that includes a processing circuitry and a memory coupled to the processing circuitry. The memory includes computer readable program instructions that, when executed by the processing circuitry, cause the RAN node to perform operations according to embodiments disclosed herein.

Some embodiments are directed to methods of operating a user equipment, UE, node that includes receiving a master cell group, MCG, and/or secondary cell group, SCG, minimization of drive testing, MDT, configuration from a radio access network, RAN, node and configuring MDT according to the MCG MDT configuration or the SCG MDT configuration.

In some embodiments, the RAN node includes a master node, MN, and receiving MCG MDT configuration or/and the SCG MDT configuration includes receiving the MCG MDT configuration from the MN. The method includes receiving the SCG MDT configuration from a secondary node, SN and configuring MDT according to both the MCG MDT configuration and the SCG MDT configuration.

Some embodiments include performing MDT according to the MCG MDT configuration and the SCG MDT configuration simultaneously.

Some embodiments include performing MDT according to the MCG MDT configuration and the SCG MDT configuration sequentially.

Some embodiments include preferentially performing MDT according to the MCG MDT configuration or the SCG MDT configuration based on a priority indication.

Some embodiments include maintaining separate logging variables, reporting variables and/or memory storage for SCG-related MDT measurement data and MCG-related MDT measurement data.

In some embodiments, receiving the MCG MDT configuration or the SCG MDT configuration includes receiving the MCG MDT configuration and the SCG MDT configuration with a time difference between the configurations. The methods include completing MDT logging for a first received configuration of the MCG MDT configuration and the SCG MDT configuration and then beginning MDT logging for a second received configuration of the MCG MDT configuration and the SCG MDT configuration.

Some embodiments provide that receiving the MCG MDT configuration or the SCG MDT configuration receiving the MCG MDT configuration and the SCG MDT configuration with a time difference between the configurations. Embodiments include splitting a sampling space and logging MDT measurements according to the MCG MDT configuration and the SCG MDT configuration simultaneously.

In some embodiments, receiving the MCG MDT configuration or the SCG MDT configuration includes receiving the MCG MDT configuration and the SCG MDT configuration with a time difference between the configurations. Embodiments further include discarding a first received configuration of the MCG MDT configuration and the SCG MDT configuration and performing MDT logging for a second received configuration of the MCG MDT configuration and the SCG MDT configuration.

In some embodiments, receiving the MCG MDT configuration or the SCG MDT configuration includes receiving the MCG MDT configuration and the SCG MDT configuration with a time difference between the configurations. Embodiments further include only performing MDT logging for a first received configuration of the MCG MDT configuration and the SCG MDT configuration until said MDT logging for the received configuration is complete.

Some embodiments include maintaining separate MDT logging duration timers for performing MDT measurements on the MCG and the SCG.

Some embodiments include maintaining a common MDT logging timer for performing MDT measurements on the MCG and SCG.

In some embodiments, the timer stops responsive to the UE memory volume being reserved for MDT configuration for SCG or a common configuration for MCG and SCG being exceeded.

Some embodiments are directed to a user equipment, UE, configured to perform operations as disclosed herein.

Some embodiments are directed to a user equipment, UE, that includes a processing circuitry, and a memory coupled to the processing circuitry, wherein the memory comprises computer readable program instructions that, when executed by the processing circuitry, cause the UE node to perform operations according to any embodiments disclosed herein.

Some embodiments are directed to methods of operating a user equipment, UE, that include receiving an immediate minimization of drive testing, MDT, configuration for a master cell group, MCG, and an immediate MDT configuration for a secondary cell group, SCG, obtaining MDT measurements according to one of the MCG MDT configuration and the SCG MDT configuration and reporting MDT measurements according to either the MCG MDT configuration or the SCG MDT configuration except for measurements that are common to both the MCG MDT configuration and the SCG MDT configuration.

Some embodiments include transmitting an MCG MDT measurement report to a master node, MN, serving the MCG and transmitting an SCG MDT measurement report to a secondary node, SN, serving the SCG.

In some embodiments, the MCG MDT measurements and the SCG MDT measurements are transmitted to the MN and the SN in parallel.

Some embodiments provide that the MCG MDT measurements and the SCG MDT measurements are performed in split time occasions. In some embodiments, a ratio of time occasions for performing MCG MDT measurements and SCG MDT measurements is set according to a configuration parameter.

In some embodiments, the UE is configured to perform MDT measurements for the MCG and/or the SCG while in an RRC_INACTIVE state. In some embodiments, the MCG and the SCG are served by radio access network, RAN, nodes that operate according to different radio access technologies, RATs. Embodiments further include obtaining the MCG MDT configuration and SCG MDT configuration, obtaining and reporting MDT measurements for the MCG only and, when the UE camps on a cell that operates on a RAT according to the obtained SCG MDT configuration, performing MDT measurements, and reporting MDT measurement results for the SCG MDT configuration.

Some embodiments provide starting an MDT logging duration timer for the SCG after camping on a cell that operates on a RAT according to the obtained SCG MDT configuration.

Some embodiments are directed to methods of operating a user equipment, UE, including receiving an immediate minimization of drive testing, MDT, configuration for a master cell group, MCG, and an immediate MDT configuration for a secondary cell group, SCG, obtaining MDT measurements according to one of the MCG MDT configuration and the SCG MDT configuration and reporting MDT measurements according to either of the MCG MDT configuration or the SCG MDT configuration.

Some embodiments are directed to a user equipment, UE, configured to perform operations according to any embodiments disclosed herein.

Some embodiments are directed to a user equipment, UE, a processing circuitry and a memory coupled to the processing circuitry, wherein the memory includes computer readable program instructions that, when executed by the processing circuitry, cause the UE node to perform operations according to any embodiments disclosed herein.

### BRIEF DESCRIPTION OF THE DRAWINGS

FIG. 1 is a block diagram that illustrates the classification of the types of MDT.

FIG. 2 is a block diagram that illustrates the multiple architecture options available for supporting Dual Connectivity in LTE-Rel 15 in which embodiments of the inventive concepts can be implemented.

FIG. 3 illustrates bearer types based on termination points.

FIG. 4 illustrates timing of MCG and SCG MDT logging according to some embodiments.

FIG. 5 is a block diagram illustrating a network node according to some embodiments of the inventive concepts.

FIG. 6 is a block diagram illustrating a user equipment node according to some embodiments of the inventive concepts.

FIGS. 7 to 11 are flowcharts illustrating operations according to some embodiments of the inventive concepts.

FIG. 12 is a block diagram of a wireless network in accordance with some embodiments;

FIG. 13 is a block diagram of a user equipment in accordance with some embodiments

FIG. 14 is a block diagram of a virtualization environment in accordance with some embodiments;

FIG. 15 is a block diagram of a telecommunication network connected via an intermediate network to a host computer in accordance with some embodiments;

FIG. 16 is a block diagram of a host computer communicating via a base station with a user equipment over a partially wireless connection in accordance with some embodiments;

FIG. 17 is a block diagram of methods implemented in a communication system including a host computer, a base station, and a user equipment in accordance with some embodiments;

FIG. 18 is a block diagram of methods implemented in a communication system including a host computer, a base station, and a user equipment in accordance with some embodiments;

FIG. 19 is a block diagram of methods implemented in a communication system including a host computer, a base station, and a user equipment in accordance with some embodiments; and

FIG. 20 is a block diagram of methods implemented in a communication system including a host computer, a base station, and a user equipment in accordance with some embodiments.

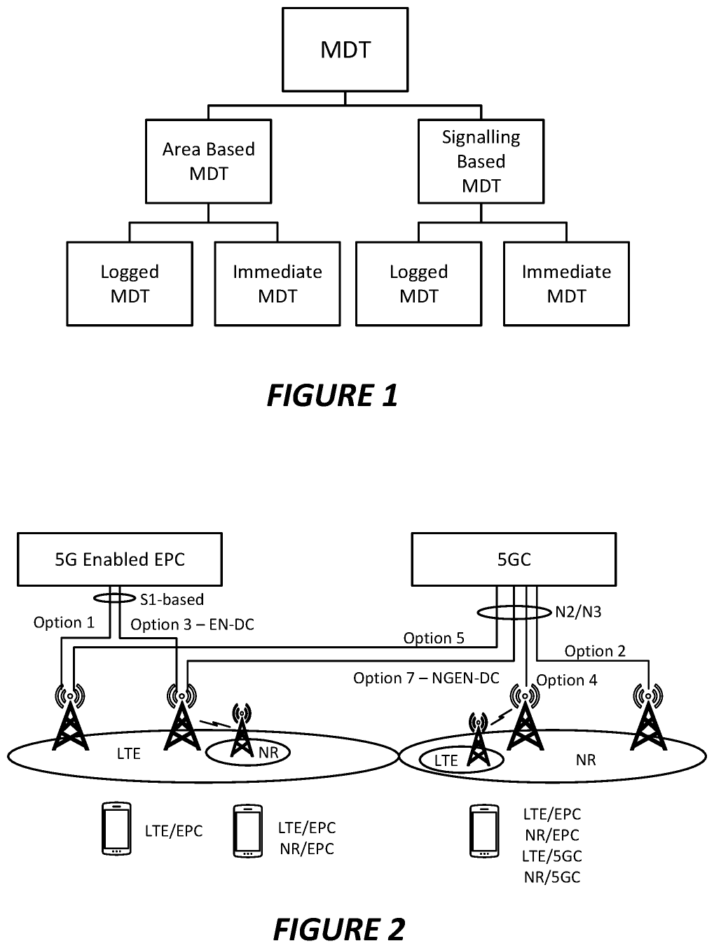

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

FIG. 2 illustrates the multiple architecture options available for supporting Dual Connectivity in LTE-Rel 15. Currently, release 15 supports up to 7 architecture options, which includes both stand alone and non-stand alone scenarios.

Some embodiments described herein provide systems/methods for implementing MDT in various dual connectivity architectures. Accordingly, dual connectivity, and in particular multi-radio access technology (RAT) dual connectivity, or MR-DC, systems will be briefly discussed. In particular, the following scenarios will be discussed for MDT implementation Option 3: EN-DC, Option 4: NE-DC and Option 7: NGEN-DC.

As part of MR-DC configuration, each UE is configured with two separate scheduled cell groups namely, a Master Cell Group (MCG) and a Secondary Cell Group (SCG). The Master Cell Group (MCG) belongs to the master node (MN) and the Secondary Cell Group belongs to the slave node (SN). Based on the type of MR-DC in question, the MN and SN could either be LTE cells or NR cells.

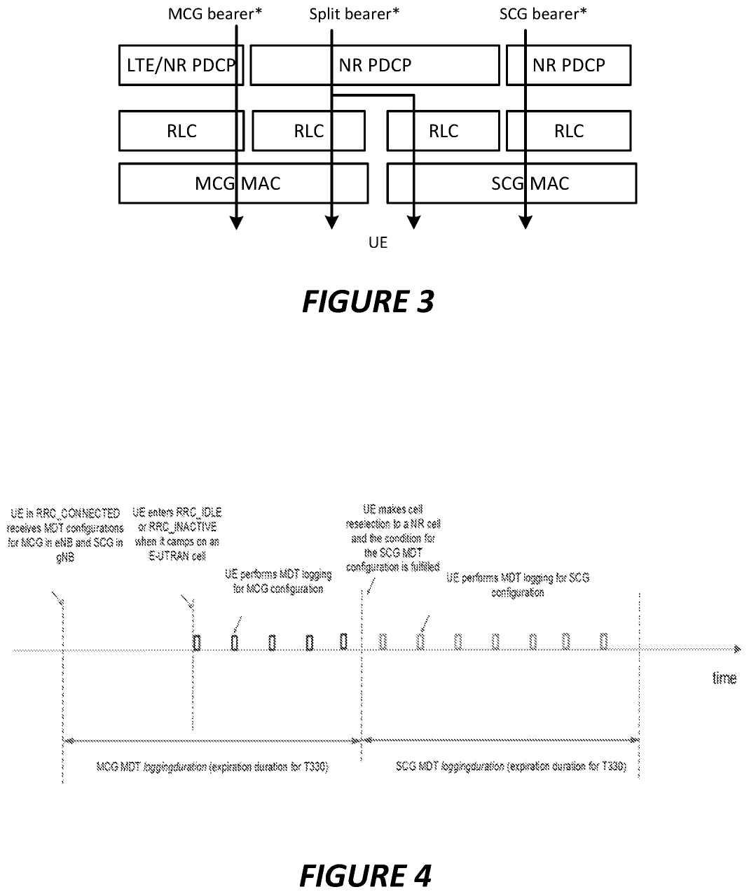

An important aspect to understand in MR-DC is the bearer termination. FIG. 3 illustrates the bearer types based on termination points. There are mainly two types of bearer termination in MR-DC, namely:

MN terminated bearer: in MR-DC, a radio bearer for which PDCP is located in the MN.

SN terminated bearer: in MR-DC, a radio bearer for which PDCP is located in the SN.

This is an important aspect since it would also decide how the network would configure the UE with MDT configuration in MR-DC scenarios.

In the context of MDT support in dual connectivity scenarios, there are a few basic considerations, specifically: visibility of DC configuration to the Operations and Management (OAM) function and impact on MDT configuration, configuration of MDT to UE via MN, SN or both, and trigger type support in MDT for MR-DC.

Visibility of DC configuration to the OAM and impact on MDT configuration may be relevant. Activation of dual connectivity to a UE is need-based and configured by the RAN nodes on case by case and UE support basis. OAM is aware about the support for dual connectivity in a specific RAN node, but OAM does not have visibility about the dual connectivity configuration of an individual UE. So, to support MDT configuration with dual connectivity, OAM needs to provide MDT configuration including configuration for secondary cell group (SCG) cells based on RAN support rather than support of the individual UE.

Configuration of MDT configuration to UE via MN, SN or both may be relevant. The next important aspect is how the MDT configuration with DC consideration is sent to the UE. Before assessing the configuration option for MDT in MR-DC scenarios, it is important to assess the measurement quantities currently available in MDT for both logged and immediate MDT as shown in Table 2 below.

Logged MDT only involves UE-specific measurements, but Immediate MDT involves measurements from both UE and the RAN node, specifically measurements M4-M7 are specific to RAN node.

Thus, specifically for Immediate MDT in MR-DC, there is a need to configure both RAN nodes that contribute towards calculating the MDT measurements.

Considering the options available to configure the MDT on UE in MR-DC scenarios, there are multiple options available.

In one approach, MDT configuration may always provided by the MN.

In another approach, MDT configuration for the UE is provided by the MN, and the SN provides its respective configuration to the UE.

In yet another approach, a flexible approach is taken for MDT configuration in DC scenarios, where the SN can be configured to provide MDT configuration based on network preference.

The first option, namely, that the complete MDT configuration including dual connectivity aspect is always provided by MN, is the simplest approach since it avoids the complexity needed to coordinate between MN and SN on which node would configure the MDT configuration for the SN towards the UE. There are some potential issues in case of MN configuring reports for SN on UE including that the MN needs to provide MDT configuration for the SN, potentially on another RAT, such as in the NE-DC or EN-DC scenarios. The trigger conditions and the configuration parameters could be different in this case which needs to be supported by the MN.

In the case of SN terminated bearer, a signaling radio bearer (SRB) is terminated directly at the SN. In that case, the measurements M4-M7 (shown in Table 2 below) need to be specifically measured at the SN, since the PDCP for the SN is separate from the MN. If the SN always needs to report these measurements to the MN, it will involve extra overhead in MN-SN signaling and coordination. It might be applicable in a split bearer scenario that part of the M4-M7 measurements can be measured in the MN since the PDCP is located in MN. However, in that case there would need to be a separate implementation for both split bearers and SN terminated bearers.

The second and third options provide more flexibility in terms of MN and SN coordination and also covers the scenario of SN terminated bearer measurements. In this case, MN and SN can perform MDT measurements independently but at the cost of more complexity in terms of MN-SN coordination for MDT configuration and also sharing SN MDT reports with MN.

In case in which only the MN provides configuration for both MN and SN, the MN needs to coordinate with the SN for collecting measurements M4-M7 in case of SN terminated bearers, while the MN would receive the measurements M1, M2, M3m M8 and M9 directly from the UE. This may entail extra complexity, since depending on whether it is split bearer or SN terminated bearer, the MN needs to collect different measurements from the SN and then merge it into measurements received for SN from UE.

Another aspect to consider is the support for SN related measurements during logged measurements. A brief overview of the types of MDT based on RRC state will now be provided.

MDT types based on RRC states: Logged MDT and Immediate MDT

In general, there are two types of MDT measurement logging, i.e., Logged MDT and Immediate MDT.

A UE is configured to perform periodical MDT logging during RRC_IDLE state after receiving the MDT configurations from the network. The UE shall report the DL pilot strength measurements (RSRP/RSRQ) together with time information, detailed location information if available, and WLAN, Bluetooth to the network using the UE information framework when it moves back to the RRC_CONNECTED state. The DL pilot strength measurement of Logged MDT is collected based on the existing measurements required for cell reselection purpose, without imposing UE to perform additional measurements.

TABLE 1
The measurement logging for Logged MDT

| MDT | RRC | |
|---|---|---|
| mode | states | Measurement quantities |
| Logged | RRC_{—} | RSRP and RSRQ of the serving cell and available UE |
| MDT | IDLE | measurements for intra-frequency/inter-frequency/ |
| | | inter-RAT, time stamp and detailed location |
| | | information if available. |

Measurements for Immediate MDT purpose can be performed by RAN and UE. There are a number of measurements (M1-M9 defined in TS 37.320) which are specified for RAN measurements and UE measurements. For UE measurements, the MDT configuration is based on the existing RRC measurement procedures for configuration and reporting with some extensions for location information.

The measurement quantities for Immediate MDT are shown in Table 2 below.

TABLE 2
The measurement quantities for Immediate MDT

| MDT | RRC | |
|---|---|---|
| mode | states | Measurement quantities |
| Immediate | RRC_{—} | M1: RSRP and RSRQ measurement by UE. |
| MDT | CONNECTED | M2: Power Headroom measurement by UE. |
| | | M3: Received Interference Power |
| | | measurement by eNB. |
| | | M4: Data Volume measurement separately |
| | | for DL and UL, per QCI per UE, by eNB. |
| | | M5: Scheduled IP Throughput for MDT |
| | | measurement separately for DL and UL, per |
| | | RAB per UE and per UE for the DL, per UE |
| | | for the UL, by eNB. |
| | | M6: Packet Delay measurement, separately |
| | | for DL and UL, per QCI per UE, see UL |
| | | PDCP Delay, by the UE, and Packet Delay |
| | | in the DL per QCI, by the eNB. |
| | | M7: Packet Loss rate measurement, |
| | | separately for DL and UL per QCI per UE, |
| | | by the eNB. |
| | | M8: RSSI measurement by UE. |
| | | M9: RTT measurement by UE. |

Currently, the UE only measures on the MN cell when it is in Inactive or Idle state, so the SN configuration during logged measurements does not add any value.

Based on the above considerations, the following MR-DC scenarios for release 15 will be considered:

Option 3 (EN-DC)

This option involves support for configuration of MDT in both E-UTRA (master cell) and NR (secondary cell) simultaneously, with trigger coming from EPC.

Option 4 (NE-DC)

This option involves support for configuration of MDT in both NR (master cell) and E-UTRA (secondary cell) simultaneously, with trigger coming from 5GC. This option is a more natural step to start in terms of DC scenario support since it is an evolution of the current standardization activity for MDT in 5GC and NR as a priority.

Option 7 (NGEN-DC)

This option is unique in the sense that it covers 5G core as well as E-UTRA which complicates in the sense that the 5GC MDT triggers agreed for NR cannot be reused since it would contain beam-specific configuration. Moreover, the legacy LTE mechanism cannot be used, since that is based on EPC.

There are some problems with the existing approach. Currently, the MDT configuration and reporting mechanism only supports a single radio access technology in dual connectivity scenarios. In release 14 for LTE and release 15 for NR alone and with E-UTRA, dual connectivity support was added in 3GPP specification which allows the UE to actually have downlink and uplink transmission with two or multiple cells simultaneously.

In the current specification, there is no support for MDT configuration and reporting for secondary cell groups (in a multi RAT scenario) configured on a UE and thus there is a requirement for an enhancement in current MDT functionality in release 14 along with release 16 work on introducing MDT for NR cells.

Some embodiments described herein provide enhanced mechanisms for configuring MDT measurements for secondary cell groups in MR-DC scenarios along with optimizations in MDT reporting during dual connectivity scenarios. Some embodiments described herein may also provide mechanisms to handle the simultaneous logging of MDT measurements for a master cell group and a secondary cell group along with other variants of MDT logging. Some embodiments described herein may also provide mechanism to handle MDT configuration in scenarios with separate OAM for the master cell group and the secondary cell group. Some embodiments described herein may also cover provision for management nodes to provide RAT-specific MDT triggers.

Accordingly, some embodiments described herein may provide multiple configuration options for secondary cell group from Management nodes entity covering multiple RAN deployment scenarios. Some embodiments described herein may provide MDT measurement logging and reporting optimizations by UE in case of dual connectivity scenarios. Further, some embodiments described herein may provide a mechanism for the RAN to provide an indication towards the UE on handling of MCG and SCG reports, and also methods at the UE to handle simultaneous configuration in dual connectivity scenarios.

Some embodiments described herein may provide methods to enable RAN nodes to enhance the MDT configurations for dual connectivity scenarios including but not limited to the following scenarios: EN-DC, NE-DC, NG-EN-DC, NR-NR DC and E-UTRA-E-UTRA DC.

Some embodiments described herein may also provide multiple mechanisms for Management nodes to trigger the RAN node to activate MDT and collect MDT measurements for secondary cell groups if the UE is configured with dual connectivity.

Embodiment 1a: In one embodiment, one or more management nodes, such as OAM functions, provide separate MDT configurations for a Master Cell Group (MCG) in a Master Node (MN) and a Secondary Cell Group (SCG) in a Slave Node (SN) for a UE based on a specific type of Radio Access technology and support for MDT type. The MDT configuration for the MCG may be provided to the MN for provision to the UE, and the MDT configuration for the SCG may be provided to the MN or the SN for provision to the UE. The MDT configurations may be applied by the UE as described herein.

Embodiment 1b: The management nodes for the MCG and the SCG may be separate nodes in some embodiments. In other embodiments, the management nodes may be the same for the MCG and the SCG.

Embodiment 1c: In one embodiment, a management node can provide separate MDT configurations for the MCG in the MN and the SCG in the SN based on the respective support by the MN and the SN for specific 3GPP release of MDT.

Embodiment id: In one embodiment, the RAN node (i.e., the MN or SN) configures the UE with a logged MDT configuration during dual connectivity scenarios in one of following methods:

Method 1: Only provide one MDT measurement configuration, for either MCG or SCG. Under existing approaches, a UE can perform MDT measurements using a logged MDT configuration in RRC_IDLE mode for only one cell at a time.

Method 2: Provide MDT configurations for both MCG and SCG with an indication about whether the UE should log data for both the MCG and the SCG. That is, in some embodiments, a UE may be configured to perform MDT measurements using a logged MDT configuration in RRC_IDLE mode for both an MCG and an SCG as described herein.

In some cases, the RAN node may provide an indication as to whether the UE should overwrite previous configurations. In some cases, the RAN node may provide an indication to the UE to complete logging for a specific cell first (for example, based on priority or sequence) and then start logging for a next received MDT configuration. For example, the RAN node may provide an MCG MDT configuration and an SCG MDT configuration and indicate that the UE should complete the logging for the MCG first and then start logging for the SCG.

For Method 2, an embodiment from UE perspective is that UE assigns separate logging variables, reporting variables and memory storages for SCG and MCG specific measurements data.

For Method 2, in an embodiment, the RAN node (MN or SN) provides a priority indicator in MDT configuration between MCG and SCG logging to the UE. The UE may perform logging in a cell based on the priority indicator.

Embodiment 1e: The scenario in embodiments 1a and 1c covers the situation when the MCG does not support the methods of activating MDT defined in Release 16 but SCG does and vice versa.

Embodiment 1f: In one embodiment, if a UE receives logged MDT configuration for master cell groups (MCG) and secondary cell group (SCG) with a time difference between the configurations (e.g., if the configurations are received in separate messages with a time difference between them), MDT logging in UE can be handled in one or multiple of following ways (but not limited to): (a) complete MDT logging for the first received configuration (MCG or SCG), report the logs and then start MDT logging for the next respective cell (MCG or SCG); or (b) split the UE MDT sampling space into half or another configured or predefined ratio and log the MDT measurements for MCG and SCG simultaneously; or (c) remove the first received MDT configuration and only log the last received MDT configuration; or (d) only keep the first received MDT configuration until logging is complete, and ignore or NACK all subsequent MDT configuration requests until MDT logging is completed for the first request.

Embodiment 2a: In one embodiment, the two management nodes that are responsible for the Master cell group (MCG) in the Master Node (MN) and the Secondary Cell group (SCG) in the Slave Node (SN) respectively can coordinate to provide a common configuration for the UE.

In a sub-embodiment, the respective management nodes of the MCG and the SCG may coordinate to provide the simultaneous MCG- and SCG-related MDT configurations towards the UE. In this way, the MDT reports generated by the UE can include time synchronized MDT measurements for MCG and SCG. That is, the UE could perform simultaneous or time synchronized measurements on the MCG and SCG and provide a single report or time-synchronized reports on both the MCG and SCG conditions. Such reports could enable detection of problems and/or provide performance evaluations on QoS and coverage aspects in dual connectivity or carrier aggregation scenarios.

Embodiment 2b: In one embodiment, a management node can provide a generic MDT configuration towards a RAN node (MN or SN). The RAN node can modify the configuration based on whether it is acting as a slave node or master node for a particular UE.

Embodiment 2c: In one embodiment, a management node can provide an MDT configuration for a UE that contains both MCG- and SCG-related parameters towards a RAN node (MN or SN). If the RAN node is acting as a MN relative to the UE, the RAN node may choose MCG-related parameters to activate the MDT at the RAN node and conveys corresponding parameters to the UE. Conversely, if the RAN node is acting as a slave node relative to the UE, the RAN node may choose the SCG-related parameters to activate the MDT at RAN node and convey corresponding parameters to UE.

Embodiment 3: In one embodiment, the above embodiments are valid in scenarios when a specific Radio Access Node (RAN) node acts as both a Master node and a Slave node relative to different UEs. That is, a RAN node may implement different MDT configurations based on whether it is acting as a MN, a SN, or both.

Embodiment 4: In one embodiment, unless the MDT configuration type is stated, all the above embodiments cover all the possible MDT configurations types and associated subtypes including but not limited to Management based MDT, Area based MDT, and Signaling based MDT.

Embodiment 5: In one embodiment, all the above embodiments cover all the possible dual connectivity scenarios including but not limited to EN-DC, NE-DC, NG-EN-DC, NR NR DC, and E-UTRA-E-UTRA DC.

Embodiment 6: In one embodiment, all the above embodiments also cover the MDT implementation in Carrier Aggregation scenario where the secondary cell group (used for dual connectivity) may be replaced by a secondary cell providing Carrier Aggregation.

Embodiment 7: In another embodiment, the management nodes in all the above embodiments may consists of network manager, domain manager, element manager or a combination of any these entities.

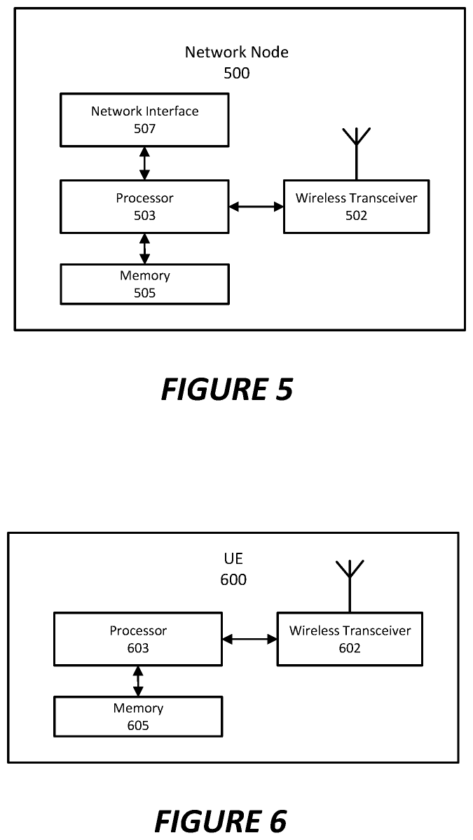

FIG. 5 is a block diagram illustrating elements of a network node 500 of a communication system. The network node 500 may implement a RAN node and/or a CN node in the communication system. For example, the network node 500 may implement a gNodeB or eNodeB.

As shown, the network node may include a network interface circuit 507 (also referred to as a network interface) configured to provide communications with other nodes (e.g., with other base stations, RAN nodes and/or core network nodes) of the communication network. The network node 500 may also include a wireless transceiver circuit 502 for providing a wireless communication interface with UEs. The network node 500 may also include a processor circuit 503 (also referred to as a processor) coupled to the transceiver circuit 502 and the network interface 507, and a memory circuit 505 (also referred to as memory) coupled to the processor circuit. The memory circuit 505 may include computer readable program code that when executed by the processor circuit 503 causes the processor circuit to perform operations according to embodiments disclosed herein. According to other embodiments, processor circuit 503 may be defined to include memory so that a separate memory circuit is not required.

As discussed herein, operations of the network node may be performed by processor 503, the wireless transceiver circuit 502 and/or the network interface 507. For example, the processor 503 may control the network interface 507 to transmit communications through network interface 507 to one or more other network nodes and/or to receive communications through network interface from one or more other network nodes. Moreover, modules may be stored in memory 505, and these modules may provide instructions so that when instructions of a module are executed by processor 503, processor 503 performs respective operations (e.g., operations discussed herein with respect to Example Embodiments).

FIG. 6 is a block diagram illustrating elements of a UE 600 of a communication system. As shown, the UE may include a wireless transceiver circuit 602 for providing a wireless communication interface with a network. The UE 600 may also include a processor circuit 603 (also referred to as a processor) coupled to the transceiver circuit 602 and the wireless transceiver circuit 602, and a memory circuit 605 (also referred to as memory) coupled to the processor circuit. The memory circuit 605 may include computer readable program code that when executed by the processor circuit 603 causes the processor circuit to perform operations according to embodiments disclosed herein. According to other embodiments, processor circuit 603 may be defined to include memory so that a separate memory circuit is not required.

As discussed herein, operations of the UE may be performed by processor 603 and/or the wireless transceiver circuit 602. For example, the processor 603 may control the wireless transceiver circuit 602 to transmit communications to a network node 500. Moreover, modules may be stored in memory 605, and these modules may provide instructions so that when instructions of a module are executed by processor 603, processor 603 performs respective operations (e.g., operations discussed herein with respect to Example Embodiments).

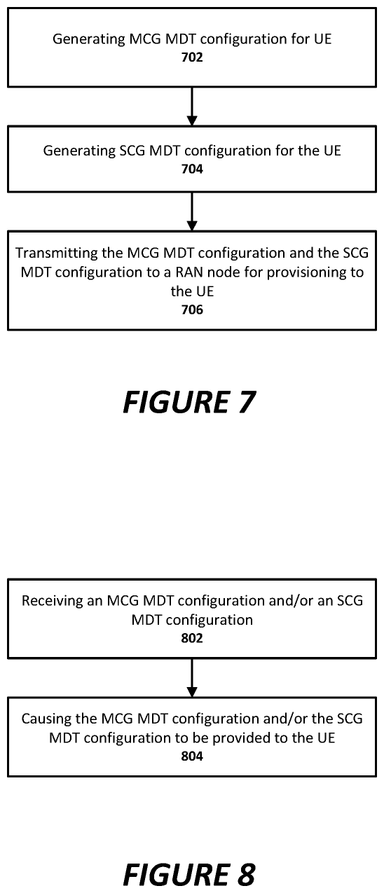

Referring to FIG. 7, a method of operating a node (500) for implementing minimization of drive testing, MDT, in a wireless communication network that supports dual connectivity according to some embodiments is provided. The method includes generating (702) a master cell group, MCG, MDT configuration for a user equipment, UE, generating (704) a secondary cell group, SCG, MDT configuration for the UE, and transmitting (706) the MCG MDT configuration and the SCG MDT configuration to one or more radio access network, RAN, nodes, for provision to the UE.

Transmitting the MCG MDT configuration includes transmitting the MCG MDT configuration to a master node, MN, serving the MCG, and wherein transmitting the SCG MDT configuration includes transmitting the SCG MDT configuration to a slave node, SN, serving the SCG.

The MCG MDT configuration and the SCG MDT configuration are generated according to different protocol levels based on different levels of protocol supported by the MN and the SN.

Transmitting the MCG MDT configuration and the SCG MDT configuration includes transmitting the MCG MDT configuration and the SCG MDT configuration to a master node, MN, serving the MCG.

Transmitting the MCG MDT configuration and the SCG MDT configuration includes transmitting the MCG MDT configuration to a master node, MN, serving the MCG and transmitting the SCG MDT configuration to a slave node, SN serving the SCG.

The MCG MDT configuration is generated by a first management node and the SCG MDT configuration is generated by a second management node, wherein the first management node transmits the MCG MDT configuration to a master node, MN, serving the MCG, and the second management node transmits the SCG MDT configuration to a slave node, SN, serving the SCG.

Transmitting the MCG MDT configuration and the SCG MDT configuration to one or more radio access network, RAN, nodes, for provision to the UE includes transmitting a generic MDT configuration to a first RAN node for provision to the UE.

Transmitting the MCG MDT configuration and the SCG MDT configuration to one or more radio access network, RAN, nodes, for provision to the UE includes transmitting an MDT configuration that includes both MCG-related configuration information and SCG-related configuration information to a first RAN node for provision to the UE.

The MDT configurations include management based MDT configurations, area based MDT configurations, and/or signaling based MDT configurations.

The UE is connected in a dual connectivity arrangement of EN-DC, NE-DC, NG-EN-DC, NR-NR DC, or E-UTRA-E-UTRA DC.

The UE is connected to a secondary cell via carrier aggregation.

The MDT configurations are generated by a management node that includes a network manager, a domain manager, an element manager or a combination of any these entities.

A first management node coordinates with a second management node of a master node, MN, to generate the MCG MDT configuration, and the first management node coordinates with a third management node of a slave node, SN, to generate the SCG MDT configuration.

Referring to FIGS. 5 and 7, a management node (500) according to some embodiments includes a processing circuit (503), and a memory (505) coupled to the processing circuit, wherein the memory includes computer readable program instructions that, when executed by the processing circuit, cause the management node to perform operations of generating (702) a master cell group, MCG, MDT configuration for a user equipment, UE, generating (704) a secondary cell group, SCG, MDT configuration for the UE, and transmitting (706) the MCG MDT configuration and the SCG MDT configuration to one or more radio access network, RAN, nodes, for provision to the UE.

Referring to FIG. 8, a method of operating a radio access network, RAN, node, (500) for implementing minimization of drive testing, MDT, in a wireless communication network that supports dual connectivity according to some embodiments is provided. The method includes receiving (802) a master cell group, MCG, or secondary cell group, SCG, MDT configuration for a user equipment, UE, from a management node, and provisioning (804) the MCG MDT configuration and/or the SCG MDT configuration to the UE.

The method may further include provisioning the MCG MDT configuration and the SCG MDT configuration to the UE.

The RAN node includes a master node that serves the MCG or a slave node that serves the SCG.

One of the MCG MDT configuration or the SCG MDT configuration includes a logged MDT configuration.

The method may further include providing the UE with an indication of whether to log MDT data for the MCG or the SCG.

The method may further include providing the UE with an indication of whether to logged MDT data for both the MCG and the SCG.

The method may further include providing the UE with an indication of whether to log MDT data for the MCG and the SCG sequentially.

The method may further include providing the UE with an indication of whether to overwrite an existing MDT configuration.

Receiving the MCG MDT configuration or the SCG MDT configuration includes receiving a generic MDT configuration, the method further including modifying the generic configuration with MCG related parameters or SCG related parameters prior to provisioning the MDT configuration to the UE.

Receiving the MCG MDT configuration or the SCG MDT configuration includes receiving an MDT configuration that includes both MCG related parameters and SCG related parameters.

Referring to FIGS. 5 and 8, node (500) is provided according to some embodiments. In some embodiments, the node is a radio access network, RAN, node while is some embodiments the node 500 is a management node. The node 500 includes a processing circuit (503), and a memory (505) coupled to the processing circuit, wherein the memory includes computer readable program instructions that, when executed by the processing circuit, cause the node to perform operations according of receiving (802) a master cell group, MCG, or secondary cell group, SCG, MDT configuration for a user equipment, UE, from a management node, and causing (804) the MCG MDT configuration and/or the SCG MDT configuration to be provided to the UE.

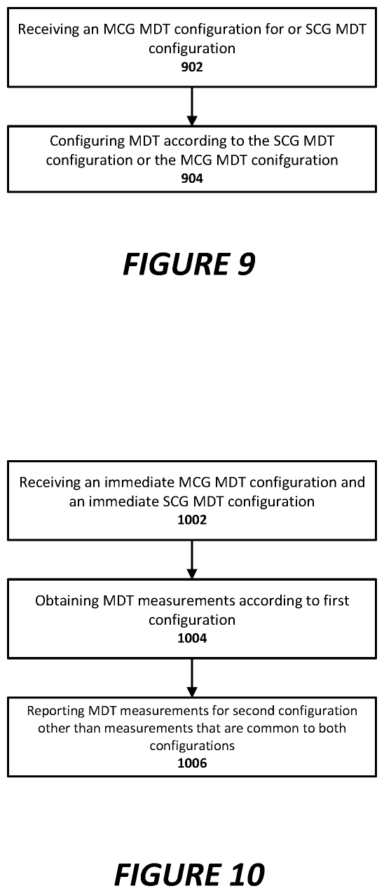

Referring to FIG. 9, a method of operating a user equipment, UE, node, (600) according to some embodiments includes receiving (902) a master cell group, MCG, or/and secondary cell group, SCG, minimization of drive testing, MDT, configuration from a node, and configuring (904) MDT according to the MCG MDT configuration or the SCG MDT configuration.

The node includes a master node, MN, and the receiving MCG MDT configuration or/and the SCG MDT configuration includes receiving the MCG MDT configuration from the MN. The method may further include receiving the SCG MDT configuration from the secondary node, SN, and configuring MDT according to both the MCG MDT configuration and the SCG MDT configuration.

The method may further include performing MDT according to the MCG MDT configuration and the SCG MDT configuration simultaneously.

The method may further include performing MDT according to the MCG MDT configuration and the SCG MDT configuration sequentially.

The method may further include preferentially performing MDT according to the MCG MDT configuration or the SCG MDT configuration based on a priority indication.

The method may further include maintaining separate logging variables, reporting variables and/or memory storage for SCG-related MDT measurement data and MCG-related MDT measurement data.

Receiving the MCG MDT configuration or the SCG MDT configuration includes receiving the MCG MDT configuration and the SCG MDT configuration with a time difference between the configurations, and the method may further include completing MDT logging for a first received configuration of the MCG MDT configuration and the SCG MDT configuration and then beginning MDT logging for a second received configuration of the MCG MDT configuration and the SCG MDT configuration.

Receiving the MCG MDT configuration or the SCG MDT configuration includes receiving the MCG MDT configuration and the SCG MDT configuration with a time difference between the configurations, and the method may further include splitting a sampling space and logging MDT measurements according to the MCG MDT configuration and the SCG MDT configuration simultaneously.

Receiving the MCG MDT configuration or the SCG MDT configuration includes receiving the MCG MDT configuration and the SCG MDT configuration with a time difference between the configurations, and the method may further include discarding a first received configuration of the MCG MDT configuration and the SCG MDT configuration and performing MDT logging for a second received configuration of the MCG MDT configuration and the SCG MDT configuration.

Receiving the MCG MDT configuration or the SCG MDT configuration includes receiving the MCG MDT configuration and the SCG MDT configuration with a time difference between the configurations, and the method may further include only performing MDT logging for a first received configuration of the MCG MDT configuration and the SCG MDT configuration until said MDT logging for the received configuration is complete.

The method may further include maintaining separate MDT logging duration timers for performing MDT measurements on the MCG and the SCG.

In some embodiments, the method may further include maintaining a common MDT logging timer for performing MDT measurements on the MCG and SCG. Some embodiments provide that the timer stops responsive to the UE memory volume being reserved for MDT configuration for SCG or a common configuration for MCG and SCG being exceeded.

Referring to FIGS. 6 and 9, a user equipment, UE, node (600) according to some embodiments includes a processing circuit (603), and a memory (605) coupled to the processing circuit, wherein the memory includes computer readable program instructions that, when executed by the processing circuit, cause the UE node to perform operations of receiving (902) a master cell group, MCG, or/and secondary cell group, SCG, minimization of drive testing, MDT, configuration from a radio access network, RAN, node, and configuring (904) MDT according to the MCG MDT configuration or the SCG MDT configuration.

Embodiment 1. In one embodiment, a UE that is configured with immediate MDT for both master cell groups (MCG) and secondary cell group (SCG) may skip the common parts of measurements in the MDT report/measurements for secondary cell group. These common measurements could include but not limited to location information as part of measurement M1, M2: Power head room measurement, and sensor information including speed and UE orientation. Common measurements made for the MCG MDT report may be re-used for the SCG MDT report. Skipping measurements that are common to both SCG and MCG may save both time and energy (battery life) of the UE.

Embodiment 2. In one embodiment, if a UE receives immediate MDT configurations for both the master cell group (MCG) and the secondary cell group (SCG) simultaneously, they can perform reporting of the MDT measurements for MCG and SCG in parallel. That is, the UE may report the MCG MDT measurements to the MN in parallel with reporting the SCG MDT measurements to the SN.

Embodiment 3. In one embodiment, if a UE receives logged MDT configurations for both master cell groups (MCG) and secondary cell group (SCG) simultaneously, the UE performs MDT logging for both MCG and SCG with split time occasions (for example, one logging occasion is for MCG and the next logging occasion is for SCG) based on a configured ratio in MDT configuration, or a UE defined ratio, or a specific event that triggers the MDT for a specific cell in MCG or SCG, i.e., MDT trigger to log out coverage.

Embodiment 4. In one embodiment, if a UE receives logged MDT configurations for the master cell group (MCG) and the secondary cell group (SCG) with a time difference (e.g., in separate messages), MDT logging in UE can be handled in one or multiple of following ways (but not limited to): UE to complete MDT logging for the first received configuration (MCG or SCG), report the logs and then start MDT logging for the next respective cell (MCG or SCG); UE to split the UE MDT sampling space into half or another configured or predefined ratio and log the MDT measurements for MCG and SCG simultaneously; UE to remove the first received MDT configuration and only log the last received MDT configuration; and/or UE to keep the first received MDT configuration till logging is complete, ignore or NACK all subsequent MDT configuration requests till MDT logging is completed for the first request.

Embodiment 5. In one embodiment, the UE is configured to perform logged MDT for secondary cell group (SCG) when the UE is in RRC_INACTIVE state.

Embodiment 6. In one embodiment, if a UE receives logged MDT configurations for both master cell groups (MCG) in MN and secondary cell group (SCG) in SN, the UE starts to perform MDT logging for MCG and stores the configuration for SCG. When the UE moves to a MN that has a RAT that is the same as that in SN, the UE may start MDT logging for SCG configuration if a pre-defined condition (for example the area scope criteria) in MDT configuration is fulfilled.

Embodiment 6a. In another sub-embodiment of Embodiment 6, a UE starts an MCG MDT logging duration timer once the corresponding configuration is conveyed to the UE and starts a SCG MDT logging duration timer after the UE moves to the RAT which is same as that in SN. Embodiments 6 and 6a are illustrated in FIG. 4.

Embodiment 6b. In a sub-embodiment of Embodiment 6, a UE starts an MCG MDT logging duration timer once the corresponding configuration is conveyed to the UE and starts an SCG MDT logging duration timer after the corresponding configuration is conveyed to the UE. In some embodiments, the UE may not start the SCG timer until SCG MDT logging begins (e.g., after the UE has completed MCG logging, or after the UE has moved to a MN that has the same RAT as the SN).

Embodiment 7. In one embodiment, a timer (such as the T330 timer defined in LTE, which can be reused) that is configured by the network is defined to represent MDT logging duration taking the dual connectivity scenario into account. The timer is defined as one of the options as follows.

Option 1. Separate timers may be used for MDT measurements for the MCG in the MN and for the SCG in the SN.

Option 2. A common timer for MCG and SCG MDT measurement expires.

In a sub-embodiment, for either of the options above, the timer stops if the UE memory volume reserved for MDT configuration for MCG or MDT configuration for SCG or a common configuration for both MCG and SCG is exceeded.

Embodiment 8. In one embodiment, unless the MDT configuration type is stated, all the above embodiments cover all the possible MDT configurations types and associated subtypes including but not limited to Management based MDT, namely, Area based MDT, and Signaling based MDT.

Embodiment 9. In one embodiment, all the above embodiments cover all the possible dual connectivity scenarios including but not limited to EN-DC, NE-DC, NG-EN-DC, NR NR DC, and E-UTRA-E-UTRA DC.

Embodiment 10. In one embodiment, all the above embodiments also cover the MDT implementation in Carrier Aggregation scenario where the secondary cell group (used for dual connectivity) would be replaced by a secondary cell providing Carrier Aggregation.

Embodiment 11. In another embodiment, the management nodes in all the above embodiments may consist of Network manager, domain manager, element manager or a combination of any these entities.

Referring to FIG. 10, a method of operating a user equipment, UE, node, (600) according to some embodiments includes receiving (1002) an immediate minimization of drive testing, MDT, configuration for a master cell group, MCG, and an immediate MDT configuration for a secondary cell group, SCG, obtaining (1004) MDT measurements according to one of the MCG MDT configuration and the SCG MDT configuration, and reporting (1006) MDT measurements according to either the MCG MDT configuration or the SCG MDT configuration except for measurements that are common to both the MCG MDT configuration and the SCG MDT configuration.

The method may further include transmitting an MCG MDT measurement report to a master node, MN, serving the MCG, and transmitting an SCG MDT measurement report to a slave node, SN, serving the SCG.

The MCG MDT measurements and the SCG MDT measurements are transmitted to the MN and the SN in parallel.

The MCG MDT measurements and the SCG MDT measurements are performed in split time occasions.

A ratio of time occasions for performing MCG MDT measurements and SCG MDT measurements is set according to a configuration parameter.

The UE is configured to perform MDT measurements for the MCG and/or the SCG while in an RRC_INACTIVE state.

The MCG and the SCG are served by radio access network, RAN, nodes that operate according to different radio access technologies, RATs, and the method may further include obtaining the MCG MDT configuration and SCG MDT configuration, obtaining and reporting MDT measurements for the MCG only, and when the UE camps on a cell that operates on a RAT according to the obtained SCG MDT configuration, performing MDT measurements and reporting MDT measurement results for the SCG MDT configuration.

The method may further include starting an MDT logging duration timer for the SCG after camping on a cell that operates on a RAT according to the obtained SCG MDT configuration.

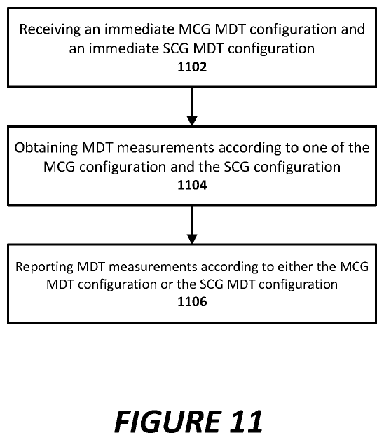

Referring to FIG. 11, a method of operating a user equipment, UE, node, (600) according to some embodiments includes receiving (1102) an immediate minimization of drive testing, MDT, configuration for a master cell group, MCG, and an immediate MDT configuration for a secondary cell group, SCG, obtaining (1104) MDT measurements according to one of the MCG MDT configuration and the SCG MDT configuration, and reporting (1106) MDT measurements according to either of the MCG MDT configuration or the SCG MDT configuration.

Referring to FIGS. 6 and 10, a user equipment, UE, node according to some embodiments includes a processing circuit (603), and a memory (605) coupled to the processing circuit, wherein the memory includes computer readable program instructions that, when executed by the processing circuit, cause the UE node to perform operations of receiving (1002) an immediate minimization of drive testing, MDT, configuration for a master cell group, MCG, and an immediate MDT configuration for a secondary cell group, SCG, obtaining (1004) MDT measurements according to one of the MCG MDT configuration and the SCG MDT configuration, and reporting (1006) MDT measurements according to either the MCG MDT configuration or the SCG MDT configuration except for measurements that are common to both the MCG MDT configuration and the SCG MDT configuration.

Some embodiments relate to MDT Measurement Configuration.

Embodiment 1. A method of operating a node (500) for implementing minimization of drive testing, MDT, in a wireless communication network that supports dual connectivity, the method comprising:

generating (702) a master cell group, MCG, MDT configuration for a user equipment, UE;

generating (704) a secondary cell group, SCG, MDT configuration for the UE; and transmitting (706) the MCG MDT configuration and the SCG MDT configuration to one or more radio access network, RAN, nodes, for provision to the UE.

Embodiment 2. The method of Embodiment 1, wherein transmitting the MCG MDT configuration comprises transmitting the MCG MDT configuration to a master node, MN, serving the MCG, and wherein transmitting the SCG MDT configuration comprises transmitting the SCG MDT configuration to a slave node, SN, serving the SCG.

Embodiment 3. The method of Embodiment 2, wherein the MCG MDT configuration and the SCG MDT configuration are generated according to different protocol levels based on different levels of protocol supported by the MN and the SN.

Embodiment 4. The method of Embodiment 1, wherein transmitting the MCG MDT configuration and the SCG MDT configuration comprises transmitting the MCG MDT configuration and the SCG MDT configuration to a master node, MN, serving the MCG.

Embodiment 5. The method of Embodiment 1, wherein transmitting the MCG MDT configuration and the SCG MDT configuration comprises transmitting the MCG MDT configuration to a master node, MN, serving the MCG and transmitting the SCG MDT configuration to a slave node, SN serving the SCG.

Embodiment 6. The method of Embodiment 1, wherein the MCG MDT configuration is generated by a first management node and the SCG MDT configuration is generated by a second management node, wherein the first management node transmits the MCG MDT configuration to a master node, MN, serving the MCG, and the second management node transmits the SCG MDT configuration to a slave node, SN, serving the SCG.

Embodiment 7. The method of Embodiment 1, wherein transmitting the MCG MDT configuration and the SCG MDT configuration to one or more radio access network, RAN, nodes, for provision to the UE comprises transmitting a generic MDT configuration to a first RAN node for provision to the UE.

Embodiment 8. The method of Embodiment 1, wherein transmitting the MCG MDT configuration and the SCG MDT configuration to one or more radio access network, RAN, nodes, for provision to the UE comprises transmitting an MDT configuration that includes both MCG-related configuration information and SCG-related configuration information to a first RAN node for provision to the UE.

Embodiment 9. The method of any previous Embodiment, wherein the MDT configurations comprise management based MDT configurations, area based MDT configurations, and/or signaling based MDT configurations.

Embodiment 10. The method of any previous Embodiment, wherein the UE is connected in a dual connectivity arrangement of EN-DC, NE-DC, NG-EN-DC, NR-NR DC, or E-UTRA-E-UTRA DC.

Embodiment 11. The method of any previous Embodiment, wherein the UE is connected to a secondary cell via carrier aggregation.

Embodiment 12. The method of any previous Embodiment, wherein the MDT configurations are generated by a management node that comprises a network manager, a domain manager, an element manager or a combination of any these entities.

Embodiment 13. The method of Embodiment 1, wherein a first management node coordinates with a second management node of a master node, MN, to generate the MCG MDT configuration, and the first management node coordinates with a third management node of a slave node, SN, to generate the SCG MDT configuration.

Embodiment 14. A management node (500) configured to perform operations according to any of Embodiments 1 to 13.

Embodiment 15. A management node (500) comprising:

a processing circuit (503); and

a memory (505) coupled to the processing circuit, wherein the memory comprises computer readable program instructions that, when executed by the processing circuit, cause the management node to perform operations according to any of Embodiments 1 to 13.

Embodiment 16. A method of operating a radio access network, RAN, node, (500) for implementing minimization of drive testing, MDT, in a wireless communication network that supports dual connectivity, the method comprising:

receiving (802) a master cell group, MCG, or secondary cell group, SCG, MDT configuration for a user equipment, UE, from a management node; and

provisioning (804) the MCG MDT configuration and/or the SCG MDT configuration to the UE.

Embodiment 17. The method of Embodiment 16, further comprising provisioning the MCG MDT configuration and the SCG MDT configuration to the UE.

Embodiment 18. The method of Embodiment 16, wherein the RAN node comprises a master node that serves the MCG or a slave node that serves the SCG.

Embodiment 19. The method of Embodiment 16, wherein the one of the MCG MDT configuration or the SCG MDT configuration comprises a logged MDT configuration.

Embodiment 20. The method of Embodiment 19, further comprising: providing the UE with an indication of whether to log MDT data for the MCG or the SCG.

Embodiment 21. The method of Embodiment 19, further comprising: providing the UE with an indication of whether to logged MDT data for both the MCG and the SCG.

Embodiment 22. The method of Embodiment 19, further comprising: providing the UE with an indication of whether to log MDT data for the MCG and the SCG sequentially.

Embodiment 23. The method of Embodiment 16, further comprising: providing the UE with an indication of whether to overwrite an existing MDT configuration.

Embodiment 24. The method of Embodiment 16, wherein receiving the MCG MDT configuration or the SCG MDT configuration comprises receiving a generic MDT configuration, the method further comprising modifying the generic configuration with MCG related parameters or SCG related parameters prior to provisioning the MDT configuration to the UE.

Embodiment 25. The method of Embodiment 16, wherein receiving the MCG MDT configuration or the SCG MDT configuration comprises receiving an MDT configuration that includes both MCG related parameters and SCG related parameters.

Embodiment 26. A radio access network node (500) configured to perform operations according to any of Embodiments 16 to 25.

Embodiment 27. A radio access network, RAN, node (500) comprising:

a processing circuit (503); and

a memory (505) coupled to the processing circuit, wherein the memory comprises computer readable program instructions that, when executed by the processing circuit, cause the RAN node to perform operations according to any of Embodiments 16 to 25.

Embodiment 28. A method of operating a user equipment, UE, node, (600) comprising:

receiving (902) a master cell group, MCG, or/and secondary cell group, SCG, minimization of drive testing, MDT, configuration from a radio access network, RAN, node; and

configuring (904) MDT according to the MCG MDT configuration or the SCG MDT configuration.

Embodiment 29. The method of Embodiment 28, wherein the RAN node comprises a master node, MN, and wherein receiving MCG MDT configuration or/and the SCG MDT configuration comprises receiving the MCG MDT configuration from the MN, the method further comprising:

receiving the SCG MDT configuration from the SN; and

configuring MDT according to both the MCG MDT configuration and the SCG MDT configuration.

Embodiment 30. The method of Embodiment 28, further comprising: performing MDT according to the MCG MDT configuration and the SCG MDT configuration simultaneously.

Embodiment 31. The method of Embodiment 28, further comprising: performing MDT according to the MCG MDT configuration and the SCG MDT configuration sequentially.

Embodiment 32. The method of Embodiment 28, further comprising:

preferentially performing MDT according to the MCG MDT configuration or the SCG MDT configuration based on a priority indication.

Embodiment 33. The method of any of Embodiments 28 to 32, further comprising: maintaining separate logging variables, reporting variables and/or memory storage for SCG-related MDT measurement data and MCG-related MDT measurement data.

Embodiment 34. The method of Embodiment 28, wherein receiving the MCG MDT configuration or the SCG MDT configuration comprises receiving the MCG MDT configuration and the SCG MDT configuration with a time difference between the configurations, the method further comprising: completing MDT logging for a first received configuration of the MCG MDT configuration and the SCG MDT configuration and then beginning MDT logging for a second received configuration of the MCG MDT configuration and the SCG MDT configuration.

Embodiment 34. The method of Embodiment 28, wherein receiving the MCG MDT configuration or the SCG MDT configuration comprises receiving the MCG MDT configuration and the SCG MDT configuration with a time difference between the configurations, the method further comprising: splitting a sampling space and logging MDT measurements according to the MCG MDT configuration and the SCG MDT configuration simultaneously.

Embodiment 35. The method of Embodiment 28, wherein receiving the MCG MDT configuration or the SCG MDT configuration comprises receiving the MCG MDT configuration and the SCG MDT configuration with a time difference between the configurations, the method further comprising: discarding a first received configuration of the MCG MDT configuration and the SCG MDT configuration and performing MDT logging for a second received configuration of the MCG MDT configuration and the SCG MDT configuration.

Embodiment 36. The method of Embodiment 28, wherein receiving the MCG MDT configuration or the SCG MDT configuration comprises receiving the MCG MDT configuration and the SCG MDT configuration with a time difference between the configurations, the method further comprising: only performing MDT logging for a first received configuration of the MCG MDT configuration and the SCG MDT configuration until said MDT logging for the received configuration is complete.

Embodiment 37. The method of Embodiment 28, further comprising: maintaining separate MDT logging duration timers for performing MDT measurements on the MCG and the SCG.

Embodiment 38. A user equipment, UE, node (600) configured to perform operations according to any of Embodiments 28 to 37.

Embodiment 39. A user equipment, UE, node (600) comprising:

a processing circuit (603); and

a memory (605) coupled to the processing circuit, wherein the memory comprises computer readable program instructions that, when executed by the processing circuit, cause the UE node to perform operations according to any of Embodiments 28 to 37.

Some embodiments relate to MDT Logging and Reporting Configuration.

Embodiment 40. A method of operating a user equipment, UE, node, (600) comprising:

receiving (1002) an immediate minimization of drive testing, MDT, configuration for a master cell group, MCG, and an immediate MDT configuration for a secondary cell group, SCG;

obtaining (1004) MDT measurements according to one of the MCG MDT configuration and the SCG MDT configuration; and

reporting (1006) MDT measurements according to either the MCG MDT configuration or the SCG MDT configuration except for measurements that are common to both the MCG MDT configuration and the SCG MDT configuration.

Embodiment 41. The method of Embodiment 40, further comprising:

transmitting an MCG MDT measurement report to a master node, MN, serving the MCG; and

transmitting an SCG MDT measurement report to a slave node, SN, serving the SCG.

Embodiment 42. The method of Embodiment 40, wherein the MCG MDT measurements and the SCG MDT measurements are transmitted to the MN and the SN in parallel.

Embodiment 43. The method of Embodiment 40, wherein the MCG MDT measurements and the SCG MDT measurements are performed in split time occasions.

Embodiment 44. The method of Embodiment 43, wherein a ratio of time occasions for performing MCG MDT measurements and SCG MDT measurements is set according to a configuration parameter.

Embodiment 45. The method of Embodiment 40, wherein the UE is configured to perform MDT measurements for the MCG and/or the SCG while in an RRC_INACTIVE state.

Embodiment 46. The method of Embodiment 40, wherein the MCG and the SCG are served by radio access network, RAN, nodes that operate according to different radio access technologies, RATs, further comprising:

obtaining the MCG MDT configuration and SCG MDT configuration,

obtaining and reporting MDT measurements for the MCG only; and

when the UE camps on a cell that operates on a RAT according to the obtained SCG MDT configuration, performing MDT measurements, and reporting MDT measurement results for the SCG MDT configuration.

Embodiment 47. The method of Embodiment 46, further comprising: starting an MDT logging duration timer for the SCG after camping on a cell that operates on a RAT according to the obtained SCG MDT configuration.

Embodiment 48. A method of operating a user equipment, UE, node, (600) comprising:

receiving (1102) an immediate minimization of drive testing, MDT, configuration for a master cell group, MCG, and an immediate MDT configuration for a secondary cell group, SCG;

obtaining (1104) MDT measurements according to one of the MCG MDT configuration and the SCG MDT configuration; and

reporting (1106) MDT measurements according to either of the MCG MDT configuration or the SCG MDT configuration.

Embodiment 49. A user equipment, UE, node (600) configured to perform operations according to any of Embodiments 40 to 48.

Embodiment 50. A user equipment, UE, node comprising:

a processing circuit (603); and

a memory (605) coupled to the processing circuit, wherein the memory comprises computer readable program instructions that, when executed by the processing circuit, cause the UE node to perform operations according to any of Embodiments 40 to 48.

Explanations are provided below for abbreviations that are mentioned in the present disclosure.

### Abbreviation Explanation

5GC 5G Core Network
5GS 5G System
AMF Access and Mobility Management Function
DC Dual Connectivity
eNB E-UTRAN NodeB
EN-DC E-UTRA-NR Dual Connectivity
E-UTRA Evolved Universal Mobile Terrestrial Radio Access
E-UTRAN Evolved Universal Mobile Terrestrial Radio Access Network
EPC Evolved Packet Core
EPS Evolved Packet System
HO Handover
LTE Long Term Evolution
MME Mobility Management Entity
MN Master Node
MR Multi-RAT
MR-DC Multi-RAT Dual Connectivity
NG Next Generation
NR New Radio
P-GW Packet Gateway
RAN Radio Access Network
RAT Radio Access Technology
RRC Radio Resource Control
SMF Session Management Function
S-GW Serving GateWay
S-MN Source MN
SN Secondary Node
S-SN Source SN
T-MN Target MN
UE User Equipment
UPF User Plane Function
CU Control Unit
DU Distributed Unit
LLS Lower-layer Split
MT Mobile Termination
RLC Radio Link Control
BAP Backhaul Adaptation Protocol
BH Backhaul
NDS Network Domain Security
DTLS Datagram Transport Layer Security
CP Control Plane
UP User Plane
UPF User Plane Function
IAB Integrated Access and Backhaul
gNB gNodeB
MDT Minimization of Drive Testing
NG-RAN node: either a gNB or an ng-eNB.
eNB: E-UTRAN Node B.
RAN node: an eNB or NG-RAN node (either a gNB or an ng-eNB).
SCG: Secondary Cell group
SN: Slave Node
MCG: Master cell group
MN: Master Node

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

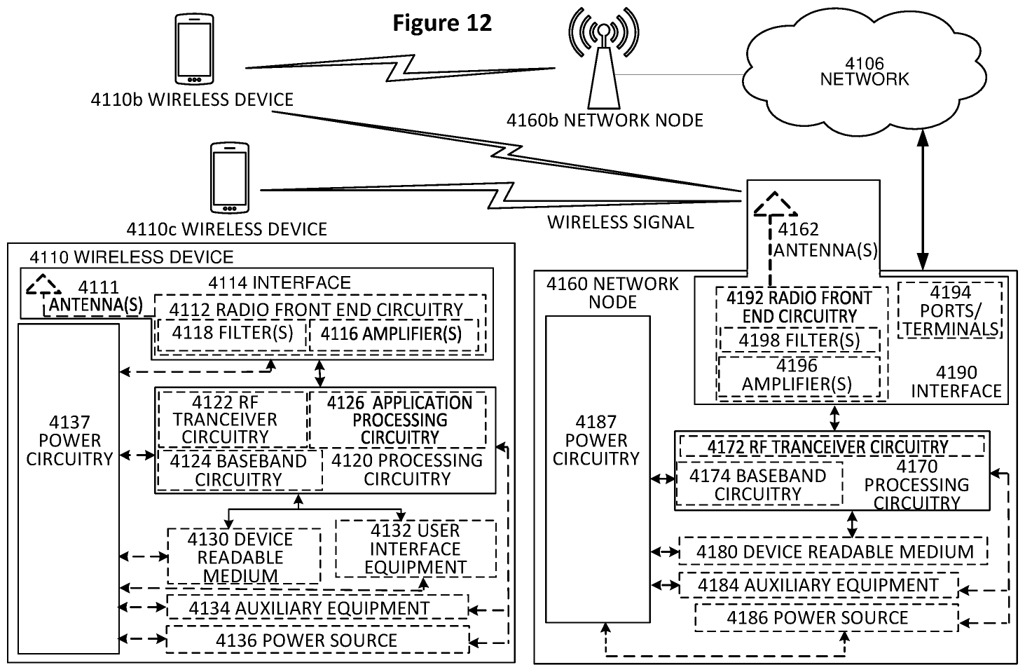

FIG. 12: A wireless network in accordance with some embodiments.

Although the subject matter described herein may be implemented in any appropriate type of system using any suitable components, the embodiments disclosed herein are described in relation to a wireless network, such as the example wireless network illustrated in FIG. 12. For simplicity, the wireless network of FIG. 12 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 12, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 12 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units.

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4190 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 12 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4114 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated. User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

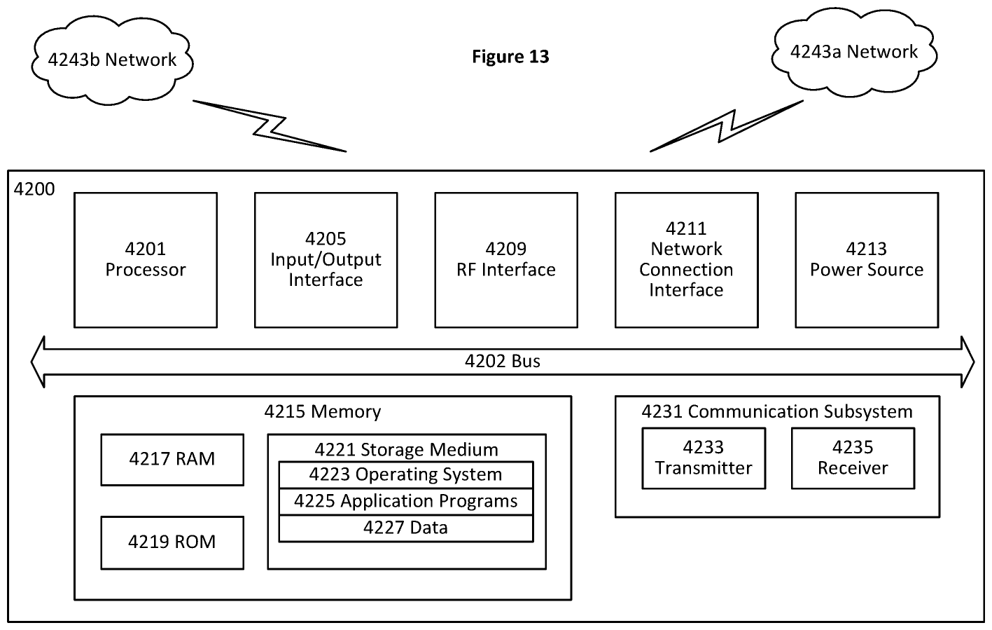

FIG. 13: User Equipment in accordance with some embodiments

FIG. 13 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-IoT UE, a machine type communication (MTC) UE, and/or an enhanced MTC (eMTC) UE. UE 4200, as illustrated in FIG. 13, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 13 is a UE, the components discussed herein are equally applicable to a WD, and vice-versa.

In FIG. 13, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4233, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 13, or only a subset of the components. The level of integration between the components may vary from one UE to another UE. Further, certain UEs may contain multiple instances of a component, such as multiple processors, memories, transceivers, transmitters, receivers, etc.

In FIG. 13, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 13, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 13, processing circuitry 4201 may be configured to communicate with network 4243b using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.QQ2, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

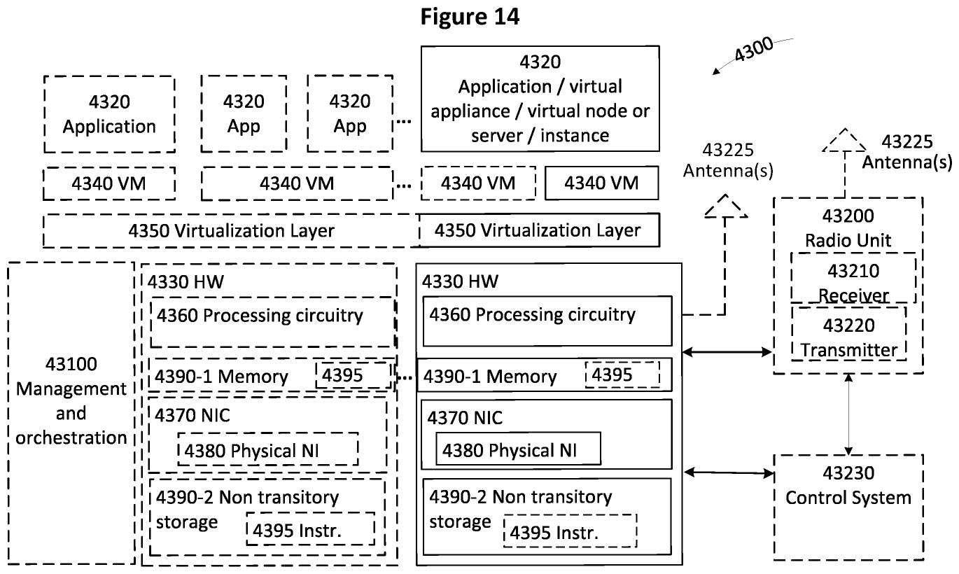

FIG. 14: Virtualization environment in accordance with some embodiments

FIG. 14 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340, comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 14, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 14.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

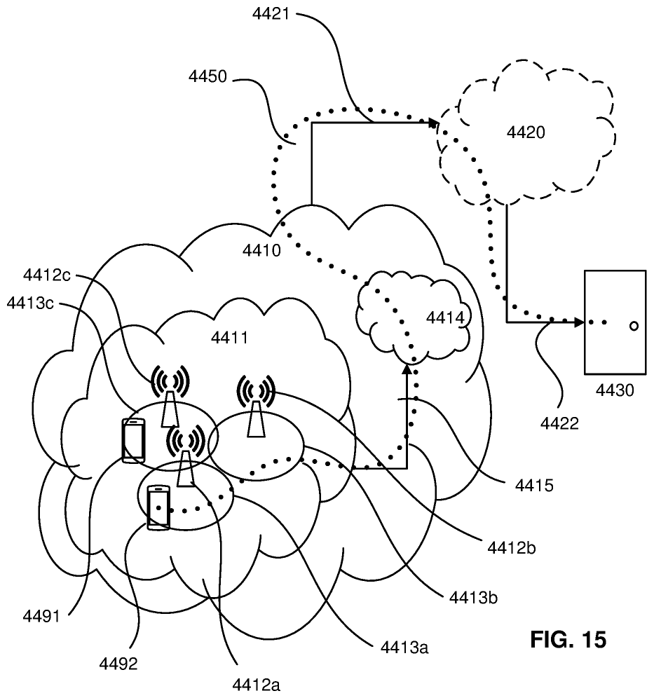

FIG. 15: Telecommunication network connected via an intermediate network to a host computer in accordance with some embodiments.

With reference to FIG. 15, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 15 as a whole enables connectivity between the connected UEs 4491, 4492 and host computer 4430. The connectivity may be described as an over-the-top (OTT) connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

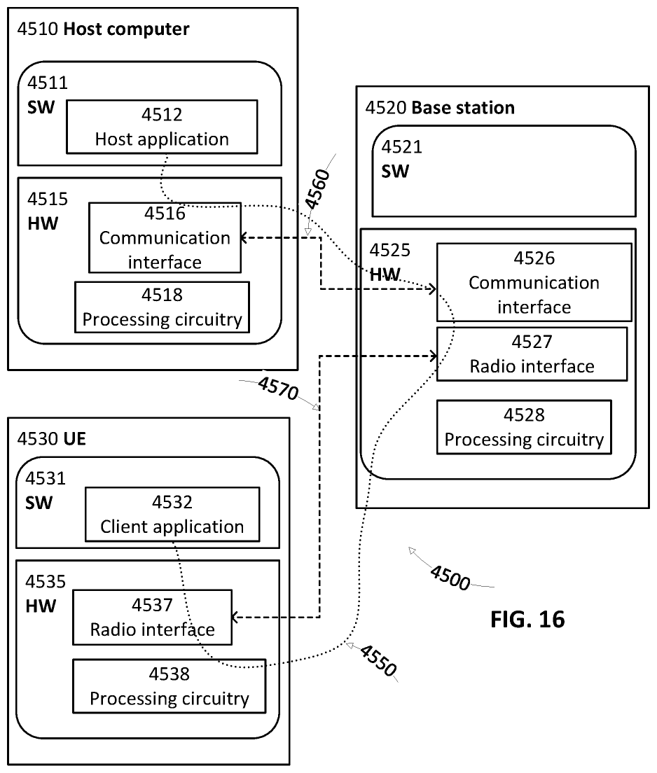

FIG. 16: Host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 16. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities. In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 16) served by base station 4520. Communication interface 4526 may be configured to facilitate connection 4560 to host computer 4510. Connection 4560 may be direct or it may pass through a core network (not shown in FIG. 16) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

It is noted that host computer 4510, base station 4520 and UE 4530 illustrated in FIG. 16 may be similar or identical to host computer 4430, one of base stations 4412a, 4412b, 4412c and one of UEs 4491, 4492 of FIG. 15, respectively. This is to say, the inner workings of these entities may be as shown in FIG. 16 and independently, the surrounding network topology may be that of FIG. 15.

In FIG. 16, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the deblock filtering for video processing and thereby provide benefits such as improved video encoding and/or decoding.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors etc.

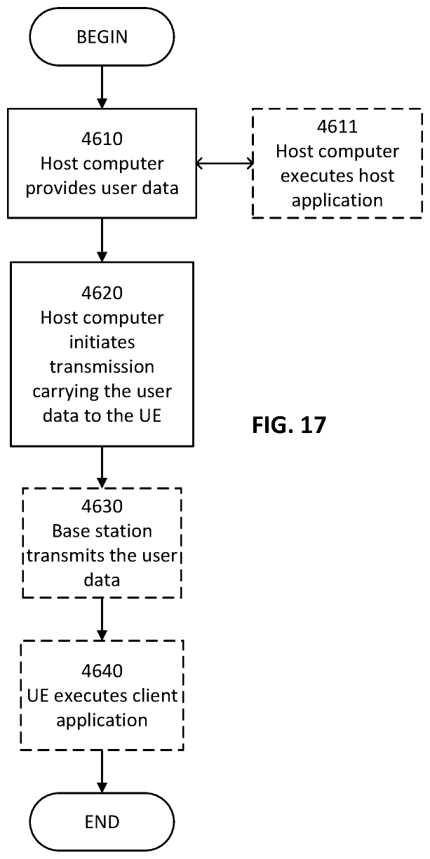

FIG. 17: Methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

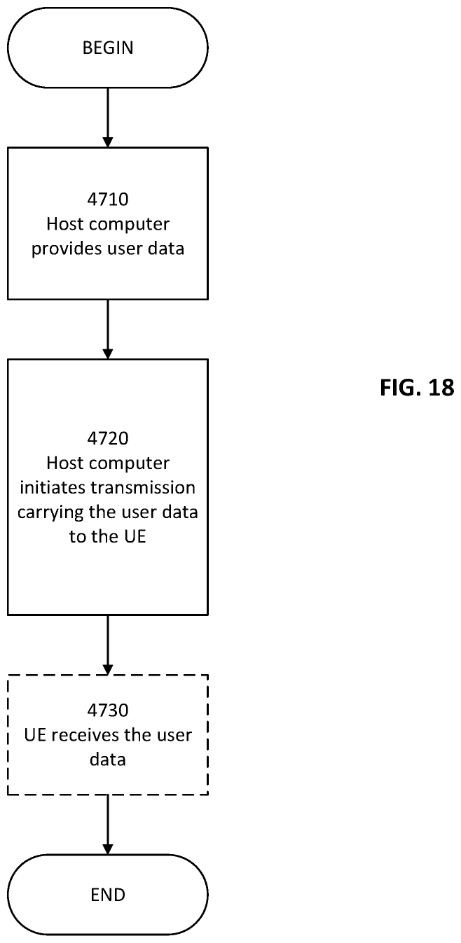

FIG. 18: Methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

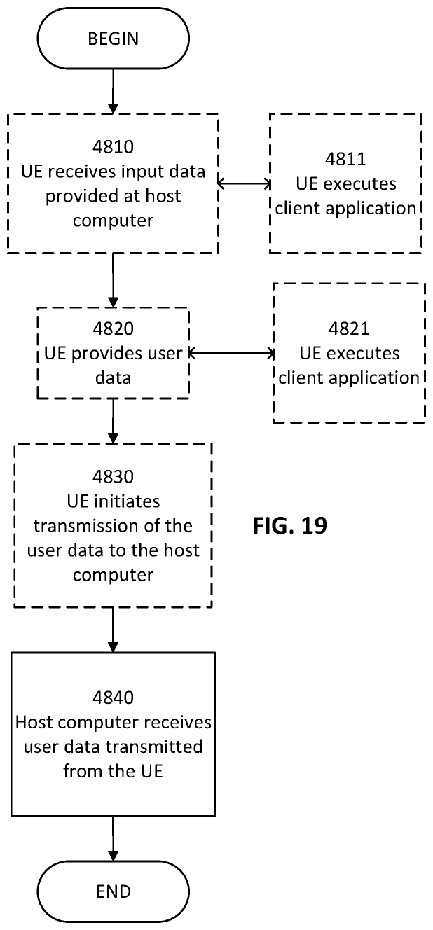

FIG. 19: Methods implemented in a communication system including a host computer, a base station and a user equipment in accordance with some embodiments.

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

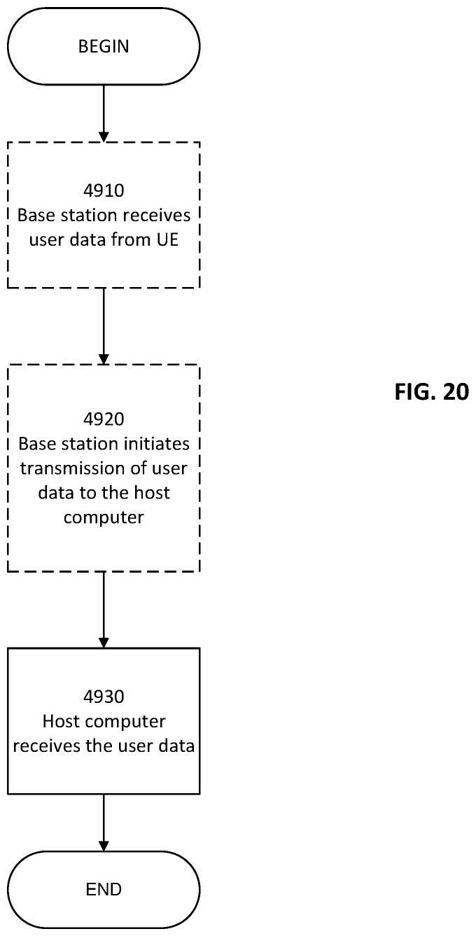

FIG. 20: Methods implemented in a communication system including a host computer, a base station and a user equipment in accordance with some embodiments.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method performed by a management node for implementing minimization of drive testing, MDT, in a wireless communication network that supports dual connectivity, the method comprising:
generating a master cell group, MCG, MDT configuration for a user equipment, UE;
generating a secondary cell group, SCG, MDT configuration for the UE; and
transmitting the MCG MDT configuration and the SCG MDT configuration to one or more radio access network, RAN, nodes.

2. The method of claim 1, wherein transmitting the MCG MDT configuration comprises transmitting the MCG MDT configuration to a master node, MN, serving the MCG, and wherein transmitting the SCG MDT configuration comprises transmitting the SCG MDT configuration to a secondary node, SN, serving the SCG.

3. The method of claim 2, wherein the MCG MDT configuration and the SCG MDT configuration are generated according to different protocol levels based on different levels of protocol supported by the MN and the SN.

4. The method of claim 1, wherein transmitting the MCG MDT configuration and the SCG MDT configuration comprises transmitting the MCG MDT configuration and the SCG MDT configuration to a master node, MN, serving the MCG.

5. The method of claim 1, wherein transmitting the MCG MDT configuration comprises transmitting the MCG MDT configuration to a master node, MN, serving the MCG.

6. The method of claim 1, wherein transmitting the SCG MDT configuration comprises transmitting the SCG MDT configuration to a secondary node, SN, serving the SCG.

7. The method of claim 1,
wherein the management node comprises a first management node and a second management node,
wherein the MCG MDT configuration is generated by a first management node and the SCG MDT configuration is generated by a second management node, and
wherein the first management node transmits the MCG MDT configuration to a master node, MN, serving the MCG, and the second management node transmits the SCG MDT configuration to a secondary node, SN, serving the SCG.

8. The method of claim 1, wherein transmitting the MCG MDT configuration and the SCG MDT configuration to one or more radio access network, RAN, nodes to the UE comprises transmitting a MDT configuration to a first RAN node.

9. The method of claim 1, wherein transmitting the MCG MDT configuration and the SCG MDT configuration to one or more radio access network, RAN, nodes comprises transmitting an MDT configuration that includes both MCG-related configuration information and SCG-related configuration information to a first RAN node.

10-14. (canceled)

15. The method of claim 1,
wherein the management node comprises a first management node that is associated with a master node, MN, and a second management node that is associated with a secondary node, SN, and
wherein the first management node coordinates with the second management node to generate the MCG MDT configuration, and the first management node coordinates with a third management node to generate the SCG MDT configuration.

16. (canceled)

17. (canceled)

18. A method of operating a radio access network, RAN, node, for implementing minimization of drive testing, MDT, in a wireless communication network that supports dual connectivity, the method comprising:
receiving a master cell group, MCG, and/or secondary cell group, SCG, MDT configuration for a user equipment, UE, from a management node; and
causing the MCG MDT configuration and/or the SCG MDT configuration to be provided to the UE.

19-22. (canceled)

23. The method of claim 18, further comprising providing the UE with an indication of whether to overwrite an existing MDT configuration.

24-28. (canceled)

29. A method of operating a user equipment, UE, node, comprising:
receiving a master cell group, MCG, and/or secondary cell group, SCG, minimization of drive testing, MDT, configuration from a radio access network, RAN, node; and
configuring MDT according to the MCG MDT configuration or the SCG MDT configuration.

30. The method of claim 29, wherein the RAN node comprises a master node, MN, and wherein receiving MCG MDT configuration or/and the SCG MDT configuration comprises receiving the MCG MDT configuration from the MN, the method further comprising:
receiving the SCG MDT configuration from a secondary node, SN; and
configuring MDT according to both the MCG MDT configuration and the SCG MDT configuration.

31-34. (canceled)

35. The method of claim 29, wherein receiving the MCG MDT configuration and/or the SCG MDT configuration comprises receiving the MCG MDT configuration and the SCG MDT configuration with a time difference between the configurations, the method further comprising completing MDT logging for a first received configuration of the MCG MDT configuration and the SCG MDT configuration and then beginning MDT logging for a second received configuration of the MCG MDT configuration and the SCG MDT configuration.

36. The method of claim 29, wherein receiving the MCG MDT configuration and/or the SCG MDT configuration comprises receiving the MCG MDT configuration and the SCG MDT configuration with a time difference between the configurations, the method further comprising splitting a sampling space and logging MDT measurements according to the MCG MDT configuration and the SCG MDT configuration simultaneously.

37-40. (canceled)

41. The method of claim 29, wherein the timer stops responsive to the UE memory volume being reserved for MDT configuration for SCG or a common configuration for MCG and SCG being exceeded.

42. (canceled)

43. (canceled)

44. A method of operating a user equipment, UE, comprising:
receiving an immediate minimization of drive testing, MDT, configuration for a master cell group, MCG, and an immediate MDT configuration for a secondary cell group, SCG;
obtaining MDT measurements according to one of the MCG MDT configuration and the SCG MDT configuration; and
reporting MDT measurements according to either the MCG MDT configuration or the SCG MDT configuration except for measurements that are common to both the MCG MDT configuration and the SCG MDT configuration.

45. The method of claim 44, further comprising:
transmitting an MCG MDT measurement report to a master node, MN, serving the MCG; and
transmitting an SCG MDT measurement report to a secondary node, SN, serving the SCG.

46. The method of claim 45, wherein the MCG MDT measurements and the SCG MDT measurements are transmitted to the MN and the SN in parallel.

47. The method of claim 44, wherein the MCG MDT measurements and the SCG MDT measurements are performed in split time occasions.

48. The method of claim 47, wherein a ratio of time occasions for performing MCG MDT measurements and SCG MDT measurements is set according to a configuration parameter.

49. The method of claim 44, wherein the UE is configured to perform MDT measurements for the MCG and/or the SCG while in an RRC_INACTIVE state.

50. The method of claim 44, wherein the MCG and the SCG are served by radio access network, RAN, nodes that operate according to different radio access technologies, RATs, further comprising:
obtaining the MCG MDT configuration and SCG MDT configuration;
obtaining and reporting MDT measurements for the MCG only; and
when the UE camps on a cell that operates on a RAT according to the obtained SCG MDT configuration, performing MDT measurements, and reporting MDT measurement results for the SCG MDT configuration.

51. The method of claim 50, further comprising starting an MDT logging duration timer for the SCG after camping on a cell that operates on a RAT according to the obtained SCG MDT configuration.

52-54. (canceled)
